(19) United States
(12) Patent Application Publication
(10) Pub. No.: US 2003/0171183 A1
(43) Pub. Date: Sep. 11, 2003

(54) Speed ratio range amplifier used with automotive continuously variable transmission and intelligent controls

(76) Inventor: John Arthur Den Besten, Western Springs, IL (US)

Correspondence Address: John A. Den Besten, 4712 Fair Elms Avenue, Western Springs, IL, 60558, US

(21) Appl. No.: 10/359,071

(22) Filed: Feb. 6, 2003

Related U.S. Application Data
(60) Provisional application No. 60/362,482, filed on Mar. 8, 2002.

(51) Int. Cl. F16H 37/02

(52) U.S. Cl. 475/210

(57) ABSTRACT

A planetary gear set is drivingly connected to the input and output of a continuously variable transmission (CVT). Of the three concentric rotatable members of the planetary gear set (sun gear, planet carrier, and ring gear) one is drivingly connected to the input of the CVT, one is drivingly connected to the output of the CVT, and the third is the output of the combined unit. Teeth ratios of the gears in the planetary set cause the range of input-to-output speed ratios of the combined unit to exceed that of the CVT alone. The expanded range of continuously variable speed ratios enables control strategy to achieve vehicle performance with a smaller engine, and improve fuel economy and emissions. The gear set also improves packaging and increases torque capacity of the CVT.

### CROSS-REFERENCE TO RELATED APPLICATIONS

This application expressly claims the benefit of earlier filing date and right of priority from the following patent application of the same title: U.S. Provisional Application Ser. No. 60/362,482 filed on Mar. 8, 2002 in the name of John A. Den Besten. The entirety of that earlier-filed, co-pending application is hereby expressly incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to power transmissions for automotive vehicles. Specifically, it relates to a means for enhancing the performance and range of applications of Continuously Variable Transmissions (CVTs); the enhanced CVTs, in turn, enable refinements to the vehicle powertrain and controls thereof, that improve fuel efficiency.

Current, typical automotive transmissions provide a series of stepped speed ratios. Evolving CVTs produce a continuous range of speed ratios, but with limited torque carrying capacity. Automatic transmissions augment vehicle launch with a hydrokinetic torque converter. These transmissions have a range of speed ratios from engaged launch to highest speed of up to 6:1.

With this limited range of speed ratios, the engine must operate over a broad range of speeds and loads to meet vehicle performance needs. This results in the engine running at less than optimum fuel efficiency and exhaust emissions output under many driving conditions. Also, at maximum performance demand such as hill climbing or open throttle acceleration, full engine power is realized at only transient points.

### BRIEF SUMMARY OF THE INVENTION

It is an object of this invention to provide a speed transmission unit having a continuously variable range of speed ratios greater than that of current practice. It is intended that this unit be a key element in an automotive powertrain, which would also include an engine, final drive(s), and other transmission elements.

It is further expected that the above unit, together with other powertrain elements, be microprocessor controlled; the microprocessor control regulates the speed transmission to run the engine at continuous maximum power through the full acceleration process. This feature improves performance with a given engine, or alternatively, enables use of a smaller engine for equivalent performance. Additionally, the microprocessor, further exploiting the speed ratio range available, operates the engine in fuel efficient regions of speeds and loads.

Another object of this invention is to increase the range of vehicles in which a CVT can be used. The range of torque limited applications is increased by the following:

The above control strategy makes possible use of a smaller, lower torque engine at a given level of vehicle performance.

The control strategy does not require torque rise of the engine thereby reducing peak torque exposure of the CVT.

One half of the input torque passes directly through the input shaft to the planetary unit, bypassing the CVT.

The speed ratio magnification of the planetary gear drive can be used to reduce the speed ratio limits at which the CVT is operated. These speed ratio limits determine minimum operating pulley pitch diameter, which, in turn, determines torque capacity and durability.

Another feature of the invention is alignment of the input and output axes of the amplified CVT unit. This facilitates packaging of the unit into vehicles with longitudinal engine installations as well as into transverse engine installations.

According to the invention, a planetary gear set is proportioned to increase the range of speed ratios beyond that which is input to the planetary set. In the example configuration, the input of the CVT is extended through the drive sheave to the sun gear of the planetary set. The output of the CVT is coupled through gears or other suitable drive to the planet carrier, turning it in the same direction as that of the CVT output. The ring gear is the output of the unit. When the planet carrier is rotated at the same speed as the sun gear, the planet gears are stationary on their axes, and the entire planetary unit rotates at the same speed. When the planet carrier is rotated slower than the sun gear (CVT speed ratio less than one), the planet gears turn backward, thereby reducing the speed of the ring gear as proportioned by the teeth ratios in the planetary set. When the planet carrier is driven faster than the sun gear (CVT speed ratio greater than one), the ring gear is driven by both the sun gear and the forward turning planet gears at proportionately higher speed ratio.

### BRIEF DESCRIPTION OF THE DRAWINGS

FIG. 1 is a pictorial drawing of a CVT coupled to a planetary gear set.

FIG. 2 is a gear layout at pitch diameters.

FIG. 3 is a cross-sectional drawing of the geared unit.

FIG. 4 is a graph showing speed ratio amplification and speed ratio ranges.

FIG. 5 is a graph illustrating control strategy at maximum acceleration.

FIG. 6 is a graph illustrating control strategy at cruise conditions.

### DETAILED DESCRIPTION OF THE INVENTION

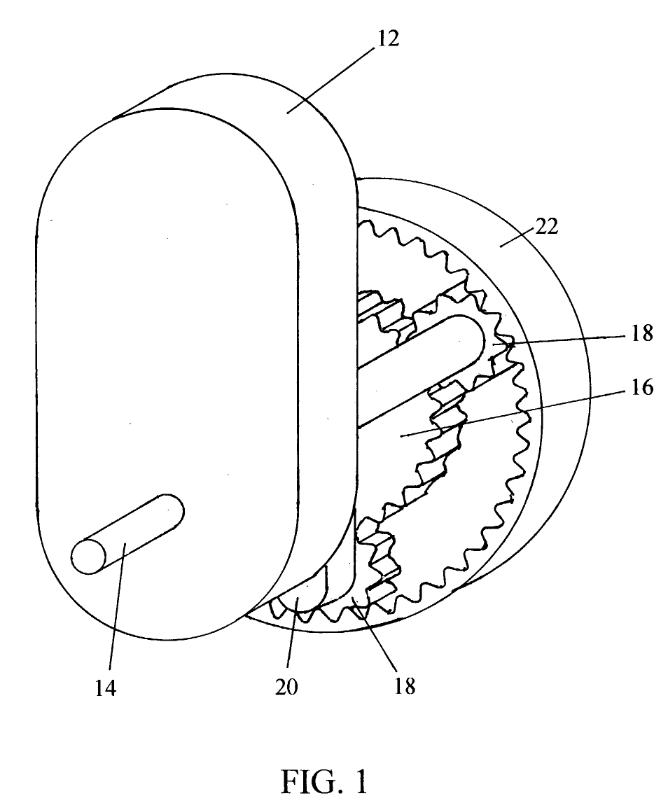

FIG. 1 illustrates a CVT 12, drivingly connected to a planetary gear set. The CVT is of the type currently evolved in the automotive industry, consisting of two variable pitch pulley sheaves connected by a composite or metal belt. In this example embodiment, the CVT input shaft 14 extends through the input sheave and is drivingly connected to the sun gear 16 of the planetary set. The output of the CVT is drivingly connected through a gear train or sprocket and chain drive to rotate the planet carrier 20 in the same direction as the CVT output. The planet gears 18 mesh with both the sun gear 16 and the ring gear 22. The ring gear connects directly, or indirectly to the vehicle final drive.

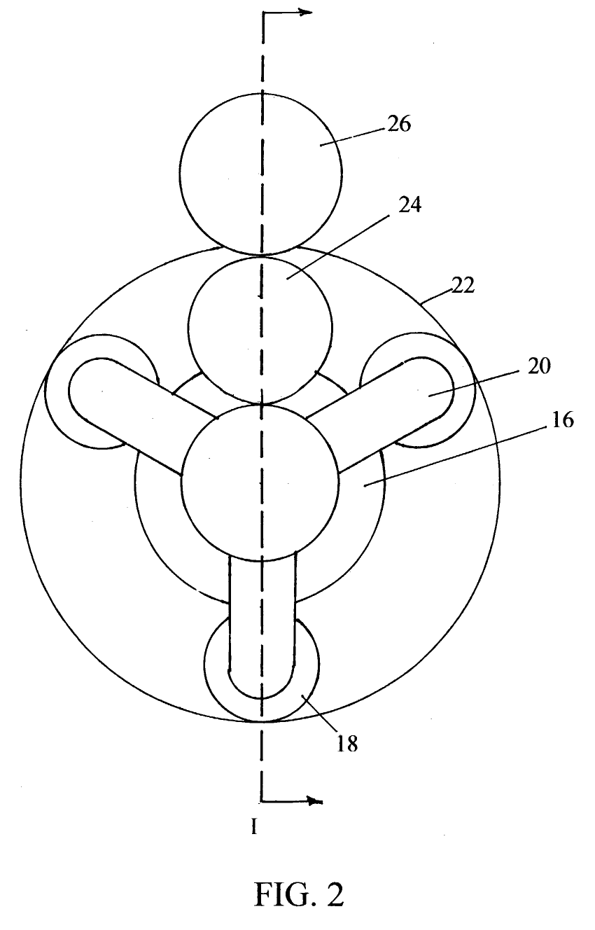

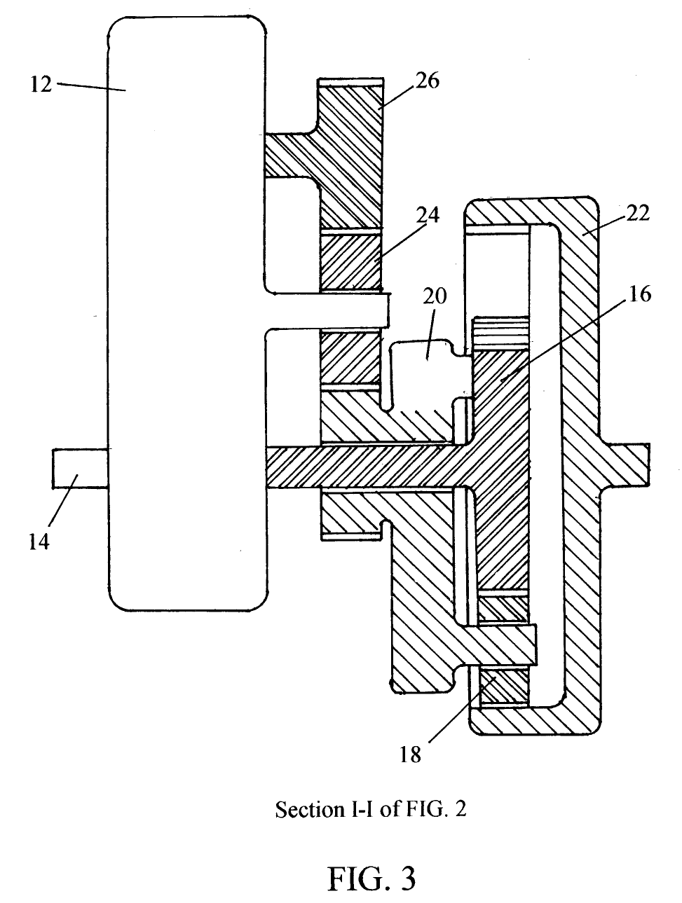

Further description of the gear arrangement is shown in FIGS. 2 and 3. The CVT output shaft is illustrated integral with a gear 26 that meshes with idler gear 24. The idler gear meshes with the gear tooth portion of planet carrier 20.

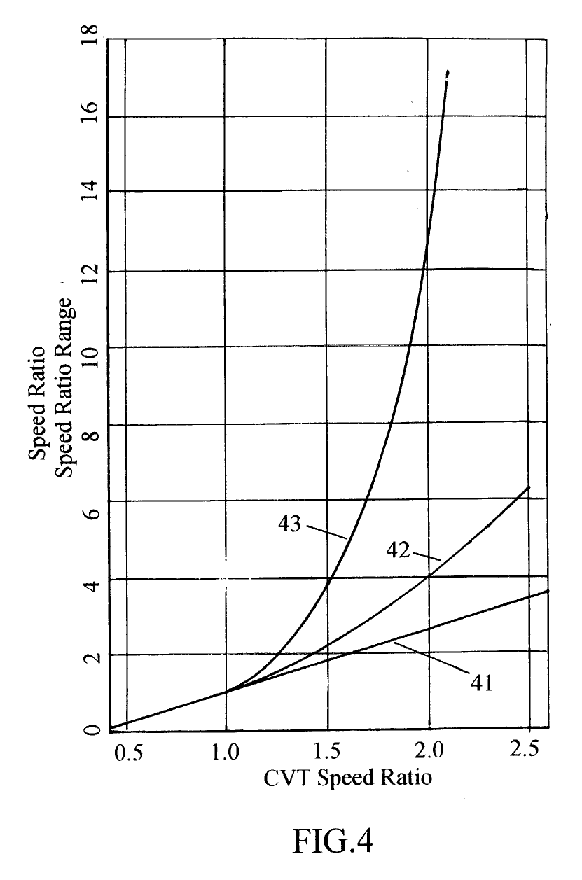

The graphs in FIG. 4 are based on an illustrative example planetary gear set as follows:

| | |
|---|---|
| Number of sun gear teeth | 30 |
| Number of planetary gear teeth | 10 |
| Number of ring gear teeth | 50 |

Line 41 of FIG. 4 shows CVT speed ratio as abcissa and the amplified speed ratio as ordinate. Curved line 42 shows the range of CVT speed ratios assuming symmetrical pulley ratios between maximum and minimum; that is the maximum is the numerical reciprocal of the minimum. Curved line 43 shows the range of amplified speed ratios. At a maximum CVT speed ratio of 1.9:1, the reciprocal minimum is 0.53:1 for a range of 3.58:1. For these CVT ratios, the amplified maximum speed ratio is 2.44:1 and the amplified minimum is 0.242:1 for a range of 10.1:1.

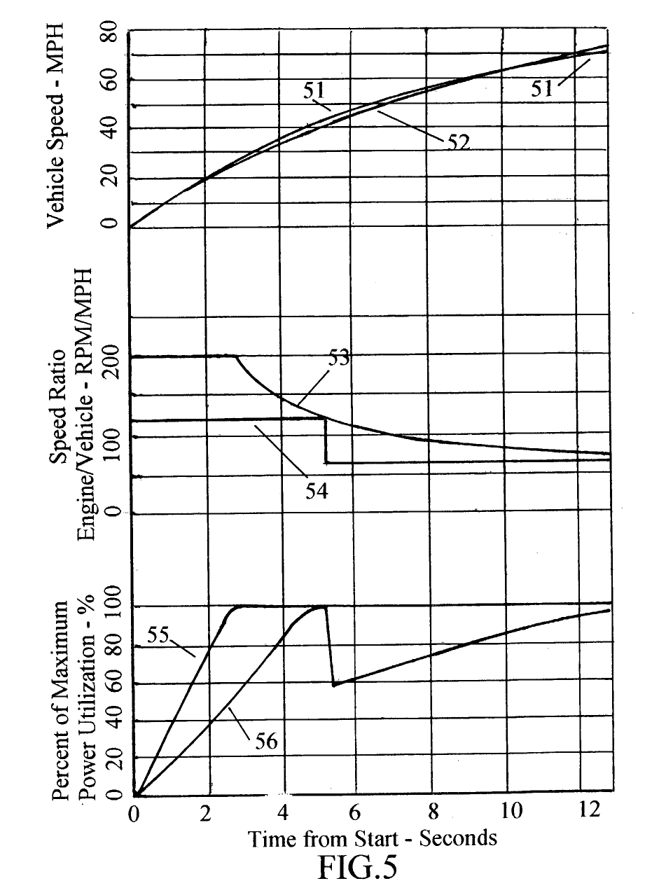

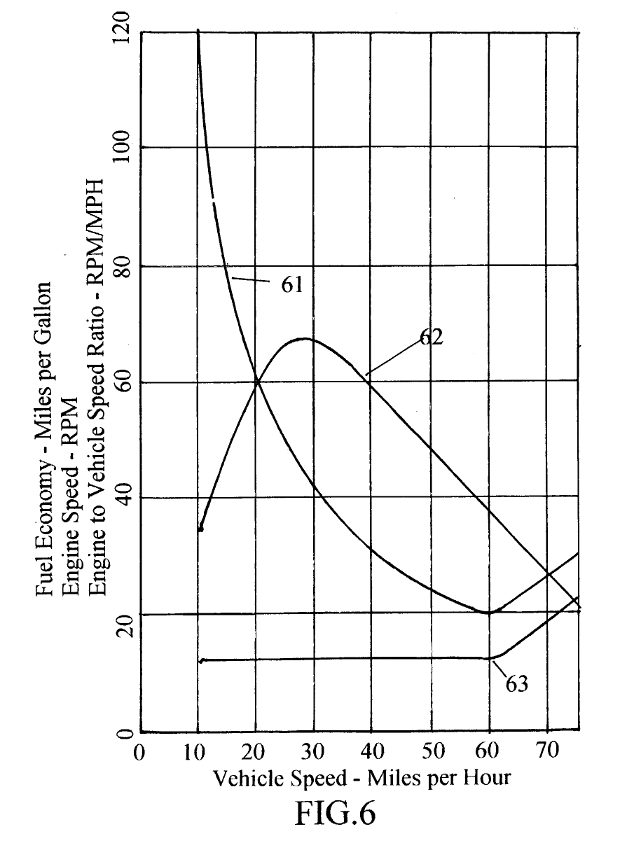

The graphs of FIGS. 5 and 6 are based on an illustrative example vehicle. This vehicle is a car based family utility vehicle of the following specifications:

| | |
|---|---|
| Curb weight | 4300 pounds |
| Maximum power | 185 bhp @ 5200 RPM |
| Gear ratio I | 2.92:1 |
| Gear ratio II | 1.57:1 |
| Gear ratio III | 1.0:1 |
| Gear ratio IV | 0.71:1 |
| Geared road speed in III gear | 107 MPH @ 4400 RPM |

FIG. 5, line 52 shows calculated acceleration of the example vehicle. Line 51 shows acceleration of the same vehicle, but with an amplified CVT, intelligent control strategy, and an engine of ¾ the size, power and torque of the baseline vehicle engine. Line 54 shows the overall engine-to-vehicle speed ratio when equipped with the standard transmission specified above. Curved line 53 illustrates the control strategy managing the amplified CVT and engine throttle. At initial launch the vehicle is traction limited; therefore the overall speed ratio is limited to 200:1. It then decreases in a pattern that maintains the engine at maximum power speed as the vehicle gains road speed. Line 55 shows that under this strategy, the engine operates at one hundred percent of it's power capacity through the acceleration process, except for the short time of initial, traction limited launch. Line 56 shows the generally less than full power utilization with the conventional transmission. This difference is the reason the CVT with intelligent control strategy can perform similar to that with conventional transmission and larger engine.

FIG. 6 shows the vehicle under cruise conditions. Line 63 is engine speed under the assumption that best balance of fuel economy, and emissions results from low speed, relatively open throttle operation. Line 61 is the speed ratio control strategy to regulate the vehicle and engine at that desired operating condition. Line 62 is the estimated steady state fuel consumption of the example vehicle. The combined effect of a smaller engine and low speed, open throttle operation cause a substantial improvement of fuel economy over that of the conventional example vehicle.

FIGS. 5 and 6 represent the operating limits of the example vehicle. FIG. 5 is maximum performance at full throttle acceleration. FIG. 6. is level road cruising. Other transient or steady state driving conditions fall between these limits. The maximum engine-to-vehicle speed ratio of FIG. 5 is 200. The minimum engine-to-vehicle speed ratio of FIG. 6 is 20. The speed ratio range between these limits is 10:1.

Referring back to FIG. 4, the amplified speed ratio range of 10:1 is developed at a CVT range of 3.58:1. At this relatively modest CVT range, the torque capacity will be at least fifty percent greater than that at the typical range of 6:1.

What I claim as my invention is:

1. A continuously variable transmission unit comprising:
A continuously variable transmission and a planetary gear set
An input shaft being drivingly connected to both the input of the continuously variable transmission and to a first coaxial rotatable member of the planetary gear set
A second coaxial rotatable member of the planetary gear set drivingly connected to the output shaft of the continuously variable transmission.
A third coaxial rotatable member of the planetary gear set drivingly connected to the final drive of the vehicle either directly or through other powertrain elements.
The ratios of the numbers of teeth of the several geared elements are such as to cause the range of input-to-output speed ratios of the combined CVT and planetary gear set to exceed that of the CVT alone.

2. A vehicle comprising the continuously variable transmission unit of claim 1, together with other powertrain components, and a microprocessor controller of these powertrain components, particularly of the engine throttle and the speed ratio control of the continuously variable transmission.

3. A control strategy for the vehicle of claim 2. that regulates the CVT to load the engine at continuous full power throughout the vehicle speed range when maximum performance is called out from the operator controls. The control strategy also regulates the CVT to operate the engine in regions of high fuel efficiency and low exhaust emissions during other driving modes.
